(19) United States
(12) Patent Application Publication
(10) Pub. No.: US 2007/0049126 A1
(43) Pub. Date: Mar. 1, 2007

(54) Connection module

(75) Inventors: Han-Cheng Hsu, Taoyuan Hsien (TW); Chen-Jung Chen, Taoyuan Hsien (TW); Ching-Man Kao, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/369,873

(22) Filed: Mar. 8, 2006

(30) Foreign Application Priority Data
Aug. 24, 2005 (TW) 94128838

(51) Int. Cl. H01R 24/00

(52) U.S. Cl. 439/676

(57) ABSTRACT

A connection module for connecting an external plug includes a body, a plurality of internal terminals and a holding device. The holding device is disposed in the body and includes a plate, a first support and a second support. When the external plug is fitted in the connection module, the external plug can be securely fixed in the corresponding connection module.

### BACKGROUND

The invention relates to a connection module, and in particular to a connection module for receiving an external plug.

With the evolution of CPUs and popularization of internet, high performance and efficient data calculation can be obtained; thus, different kinds of information services can be provided.

Connectors and hubs are usually used for connecting electronic devices, e.g., a PC or a notebook, to the internet. For example, an RJ-45 jack and an RJ-45 plug are popular and useful elements coupled each other to transmit signals from a PC to the internet. Traditionally, the size of an opening of the jack is generally larger than that of the plug to facilitate the coupling between the jack and the plug. However, this kind of connection way would easily cause the plug to shake in the jack, due to the larger opening of the jack, which will decrease the stability of signal transmission, increase the impedance between the jack and the plug, and thus, slow the signal transmission speed.

### SUMMARY

The invention provides a connection module for connecting an external plug. The connection module comprises a body, a plurality of internal terminals and a holding device. The body comprises an opening and a hole, wherein the opening receives the external plug corresponding to the body. The internal terminals are disposed in the body and electrically coupled to external terminals of the external plug. The holding device is also disposed in the body and comprises at least one protrusion used to press against the external plug when the external plug is fitted in the opening of the body.

The holding device comprises a plate, a first support passing through the hole and a second support passing through the hole. The juxtaposed first and second supports are respectively disposed, in parallel, at opposite ends of the plate.

The first and second supports respectively comprise at least one slanted surface and one extended portion. The extended portions of the first and second supports abut against a sidewall of the hole to reinforce the structure of the first and second supports. The slanted surfaces of the first and second supports are used for guiding the external plug to a correct position in the body.

The invention provides high structural stability, high quality signal transmission and low interference between pairs of the connection module and the external plug. Besides RJ-45 connectors, the conception of the invention can also apply to any kinds of connection modules for computers or other communication equipment.

### DESCRIPTION OF THE DRAWINGS

The invention can be more fully understood by reading the subsequent detailed description and examples with references made to the accompanying drawings, wherein:

FIG. 1A is a schematic view of a connection module of an embodiment of the invention;

FIG. 1B is an exploded view of the connection module of FIG. 1A;

FIG. 1C is a sectional view of the connection module of FIG. 1A;

FIG. 2A is a schematic view of the connection module of another embodiment of the invention in relation to an external plug; and

FIG. 2B is a schematic view of the connection module engaged with the external plug of FIG. 2A.

### DETAILED DESCRIPTION

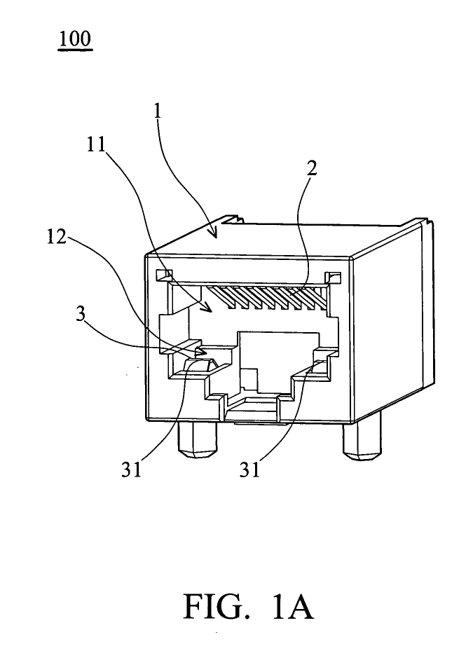

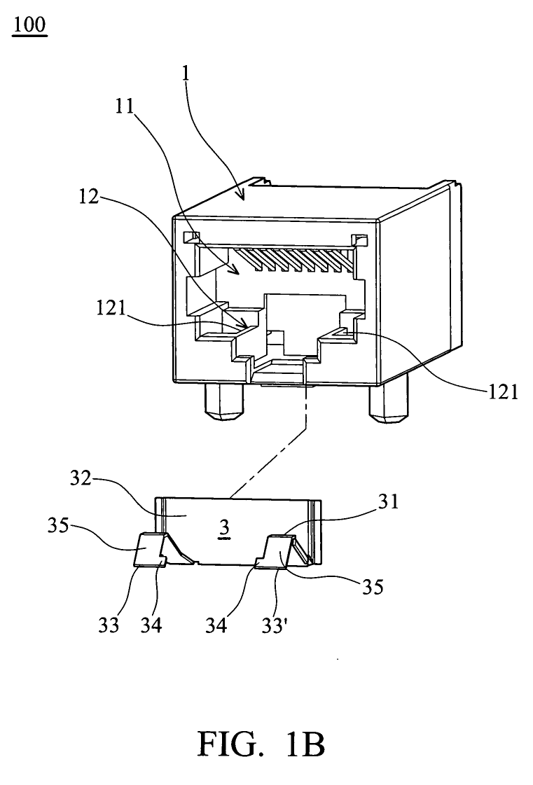

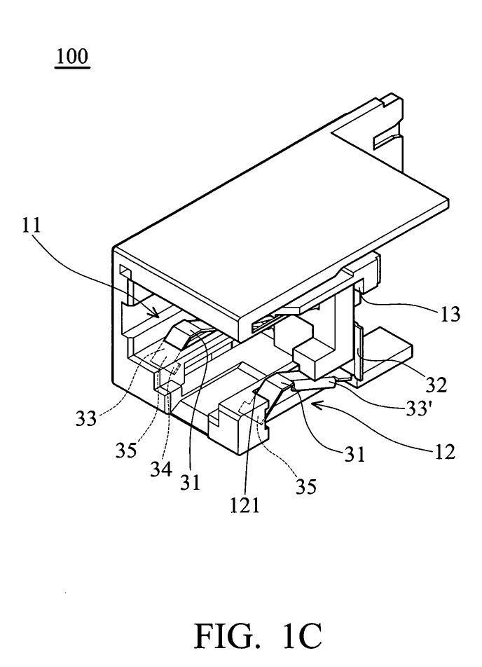

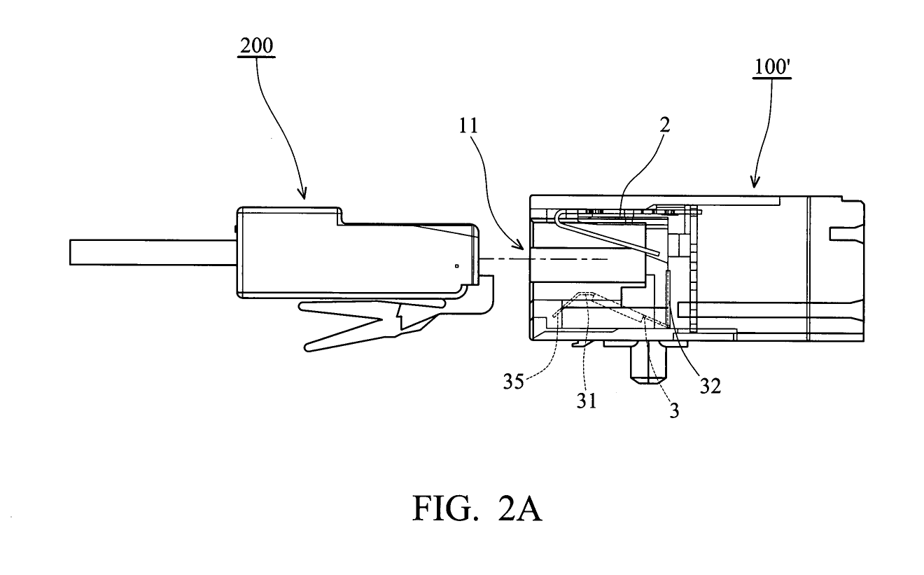

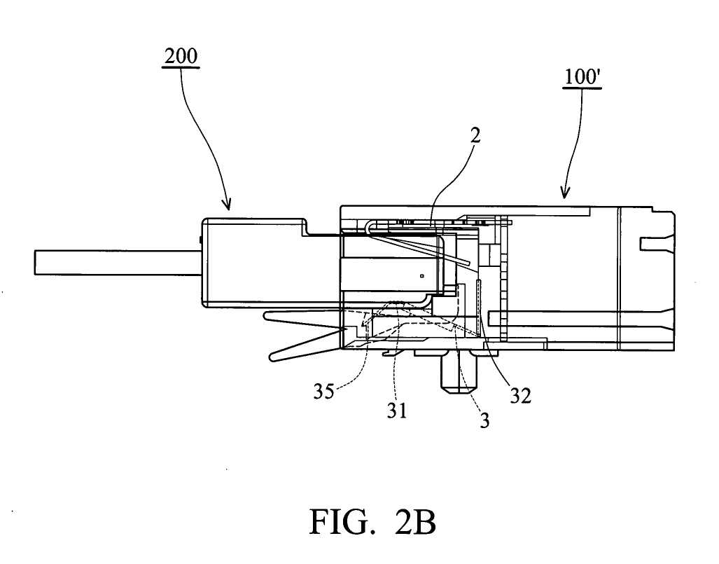

In FIG. 1A, a connection module 100 of the first embodiment of the invention is used for connecting an external plug 200 (as shown in FIGS. 2A and 2B) which has a plurality of external terminals therein. The connection module 100 comprises a body 1 having at least one slot 13 (shown in FIG. 1C), a plurality of internal terminals 2 and a holding device 3. The body 1 has an opening 11 and a hole 12. The opening 11 of the body 1 receives the external plug 200 corresponding to the body 1. The internal terminals 2 are disposed in the body 1 and electrically coupled to the external terminals of the external plug 200. The holding device 3 is also disposed in the body 1 and comprises at least one protrusion 31 for pressing against the external plug 200 when the external plug 200 is fitted in the opening 11.

FIG. 1B is an exploded view of the connection module of FIG. 1A. The holding device 3 comprises a plate 32, a first support 33 and a second support 33′. The first and second support 33 and 33′ are juxtaposed and respectively disposed in parallel at the opposite sides of the plate 32.

The first and second supports 33 and 33′ respectively comprise at least one extended portion 34 and at least one slanted surface 35. The extended portions 34 of the first and second supports 33 and 33′ abut against sidewalls 121 of the hole 12 to reinforce the structure of the first and second supports 33 and 33′. The slanted surfaces 35 of the first and second supports 33 and 33′ serve to guide the external plug 200 into the body 1, and thus, the external plug 200 can be fitted to a correct position.

FIG. 1C is a sectional view of the connection module 100. The plate 32 is positioned at different levels from that of the first and second supports 33 and 33′, and the plate 32 is engaged with the at least one slot 13 of the body 1. The first and second supports 33 and 33′ pass through the hole 12.

In FIGS. 2A and 2B, a connection module 100′ of the second embodiment of the invention differs from the first embodiment in that the hole is omitted and the holding device 3 is disposed in the opening 11.

In FIG. 2A, the protrusion 31 is projected to the opening 11 when the external plug 200 is not fitted in the opening 11. In FIG. 2B, the protrusion 31 pressing against the external plug 200 is located at the outside of the opening 11 in the body 1 when the external plug 200 is fitted in the opening 11. After the external plug 200 is moved from the opening 11, the protrusion 31 is again projected to the opening 11 (shown as FIG. 2A).

It is to be understood that the protrusion can be in various shapes to attain the object and function as mentioned above. The material of the holding device 3 is selected from a group consisting of plastic, metal, alloy, stainless or ceramic. Furthermore, the holding device 3 can be a resilient member. In this embodiment, the connection module 100 is an RJ-45 connector.

According to this invention, when one or more external plugs is or are respectively connected to the corresponding connection module, the individual external plug can be securely fixed on the corresponded connection module to prevent signal shorts therebetween, reduce signal interference and increase safety when using related electronic devices or equipment. Besides RJ-45 connectors, the connection module can be any kind of connector providing particular functions with computers or other communication equipment; thus, interference signal can be reduced.

While the invention has been described with respect to preferred embodiment, it is to be understood that the invention is not limited thereto, but, on the contrary, is intended to accommodate various modifications and equivalent arrangements included within the spirit and scope of the appended claims.

What is claimed is:

1. A connection module for connecting an external plug, comprising:
a body comprising an opening for receiving the external plug, and a hole;
a plurality of internal terminals disposed in the body for electrically coupling to the external plug; and
a holding device engaged with the hole of the body, and comprising at least one protrusion for pressing against the external plug when the external plug is fitted in the opening.

2. The connection module as claimed in claim 1, wherein the holding device comprises a plate, a first support connected with the plate and passing through the hole, and a second support connected with the plate and passing through the hole.

3. The connection module as claimed in claim 2, wherein the body further comprises a slot for engaging with the plate.

4. The connection module as claimed in claim 2, wherein the plate is positioned at different level from that of the first support and the second support.

5. The connection module as claimed in claim 4, wherein the first support and the second support are juxtaposed in parallel.

6. The connection module as claimed in claim 5, wherein the first support and the second support are disposed at opposite ends of the plate respectively.

7. The connection module as claimed in claim 2, wherein the first support and the second support respectively comprise at least one slanted surface.

8. The connection module as claimed in claim 2, wherein the first support and the second support respectively comprise at least one extended portion for abutting against a sidewall of the hole.

9. The connection module as claimed in claim 1, wherein the holding device is selected from a group consisting of plastic, metal, alloy, stainless or ceramic.

10. The connection module as claimed in claim 1, wherein the holding device comprises a resilient member.

11. The connection module as claimed in claim 1, wherein the connection module is an RJ-45 jack.

12. A connection module for connecting an external plug, comprising:
a body comprising an opening used for receiving the external plug;
a plurality of internal terminals disposed in the body for electrically coupling to the external plug; and
a holding device disposed in the body, comprising at least one protrusion for pressing against the external plug when the external plug is fitted in the opening.

13. The connection module as claimed in claim 12, wherein the holding device comprises a plate, a first support disposed in the opening and a second support disposed in the opening.

14. The connection module as claimed in claim 13, wherein the body further comprises a slot for engaging with the plate.

15. The connection module as claimed in claim 13, wherein the plate is positioned at different level from that of the first support and the second support.

16. The connection module as claimed in claim 15, wherein the first support and the second support are disposed in parallel and at opposite ends of the plate respectively.

17. The connection module as claimed in claim 13, wherein the first support and the second support respectively comprise at least one slanted surface.

18. The connection module as claimed in claim 12, wherein the holding device is made of a material selected from a group consisting of plastic, metal, alloy, stainless or ceramic.

19. The connection module as claimed in claim 12, wherein the holding device is a resilient member.

20. The connection module as claimed in claim 12, wherein the connection module is an RJ-45 jack.
